(19) United States
(12) Patent Application Publication
(10) Pub. No.: US 2021/0107274 A1
(43) Pub. Date: Apr. 15, 2021

(54) AN APPARATUS AND PROCESS FOR PRINTING WITH TACTILE AND GLITTER EFFECT ON FLEXIBLE SUBSTRATE AND PRINTED SUBSTRATE THEREOF

(71) Applicant: Ashok Chaturvedi, New Delhi (IN)

(72) Inventor: Ashok Chaturvedi, New Delhi (IN)

(21) Appl. No.: 17/047,919

(22) PCT Filed: Apr. 9, 2019
(86) PCT No.: PCT/IN2019/050287

§ 371 Date: Oct. 15, 2020

(30) Foreign Application Priority Data
Apr. 16, 2018 (IN) 201811014439

(51) Int. Cl. B41F 9/02; C09D 11/101; C09D 11/38; C09D 11/322; B41F 23/04

(52) U.S. Cl. CPC B41F 9/025; C09D 11/101; B41F 23/0409; C09D 11/322; C09D 11/38

(57) ABSTRACT

An apparatus and process for producing multicolour print with tactile and glitter or other effect on a flexible substrate (100, 400A) is disclosed. The rotogravure printing machine includes a plurality of printing stations (402, 404, 406, 408 and 410) and an inline coating station (412). Printing cylinder of at least one of the printing stations is engraved with depth (d1, d2) between 20 microns and 300 microns, to transfer large volume of radiation curable inks mixed with or without glitter. The coating station (412) provides a clear coat of radiation curable coating mixed with or without glitter, at desirable location on the substrate. The gravure or flexography based coating station may apply spot coating or overall coating based on the requirement. At least one of the printing stations and the coating station may include curing unit (422, 424, 426 and 432) for curing the printed ink and applied coating.

### FIELD OF THE INVENTION

The field of this invention relates to a printing apparatus and a process, and more specifically, to process and rotogravure printing machine adapted for printing with tactile and glitter effect on roll to roll flexible packaging substrate.

### BACKGROUND OF THE INVENTION

The history of printing presses is a long chain of steady innovations and improvements. As the demands of information dissemination continue to grow, and as competition for attention in advertising, graphic decoration and education among various media continues to grow, the techniques and technologies of printing moved forward to continue the historical progression. A tactile structure that is perceptible by touch is important and has numerous uses. Complex and colorful printed graphics, specifically tactile graphics on packaging with the effects of glittering are increasingly in demand to distinguish products and displays from normal printed products.

Many literatures disclose different techniques and apparatus to create such printing with tactile and glitter effect. For example, US2016/0068702 discloses a method of creating a rough tactile surface on a substrate using a coating composition having high aspect ratio flakes dispersed through a radiation-curable binder. The method includes the steps of preparing the radiation-curable binder composition, adding the high aspect ratio flakes to the binder composition to form a coating composition, applying the coating composition through flexo or gravure application process, transferring the coating composition onto the substrate whereby flakes extend upwardly and outwardly of the binder composition, and curing the coating composition on the substrate whereby the flakes remain oriented upwardly and outwardly to form a tactile surface to the binder.

The high aspect ratio flakes are made from polymeric films such as polyethylene terephthalate (PET), polyvinyl chloride, polycarbonate, cellulose acetate, Poly(lactic acid), polypropylene, high density polyethylene, polystyrene, nylon, polyacrylonitrile, and the like. Although the high aspect ratio flakes creates the effect of tactile and glitter in the printed substrate, however studies show that there are various environmental and health issues associated with the use of flakes in the printing.

Further the flakes described in the prior art are not very suitable for specific printing processes, such as, for example, rotogravure or flexography printing, due to their particle sizes and orientation, since they inadequately fill or clog the cells in the engraved cylinders or printing plates or cannot align correctly in the application medium. If they are employed in relatively small particle sizes in printing processes of this type, the achievable glitter effect is not sufficient in order to produce the desired sparkle level.

Further, most of the rotogravure printing machines use solvent based inks, for which hot and dry air is required to dry the ink transferred on the substrate. With the advancement of technology some machine manufacturers started using UV curable inks for printing, which are cured by UV lamps. Such UV curable inks are provided with photo initiators, which help in curing of the ink under UV light of particular wavelength. The problem associated with the UV lamps used in the curing of the inks is that, the lamps emit UV light of different wavelengths, instead of a particular wavelength required for the curing of particular ink. This makes the curing process slow resulting in limiting the line speed on the printing/coating machine.

Further, heat and other associated problem are also present in the use of UV lamps; the solvent-based inks are prone to catch fire due to the heat generated by the UV lamps. Another, drawback of UV lamps is that they have a shorter life span with de-rating output of UV light with time and need replacement frequently, to remain effective. More over due to broad spectrum of wavelengths the curing effectiveness is less hence the line speed achieved with thin layer printing may be acceptable but in case of tactile printing where the thickness and build-up of ink over the substrate surface is more, the curing becomes a challenge and line speed goes down drastically.

Therefore, there is a need for a method and system to create tactile and glitter effect on roll to roll flexible packaging substrate, without harming the environment and avoiding health hazard caused by loose flakes in the prior art for roll to roll flexible substrates, which can print at high speeds and in different colours. It is also desired to have deposition of ink in different formulations and viscosity to have rough surface with raised printing i.e. embossed or tactile or 3D effect, which can be easily felt. There is also a need of cost saving and high-speed printing using radiation curable inks.

### SUMMARY OF THE INVENTION

The present invention discloses, a high speed multicolour rotogravure printing machine with inline coating station which eliminates the drawbacks mentioned in the prior art and provides tactile effect by deposition of thick ink which can be easily felt by touch. The printing cylinder of the present invention is designed to transfer and deposit a thick layer of ink on the substrate for producing the tactile effect. Moreover printing ink mixed with glitter particles of particular specification can be used to provide glitter effect in the tactile printing. In various embodiments, glitter particles provide tactile effect in addition to glitter effect on the substrate. The printing and/or coating for producing tactile and/or glitter effect can also be registered with the text, images or any other reference mark on the substrate.

According to an embodiment of the invention, a high speed multicolour rotogravure machine for printing on flexible web substrate is described. In one embodiment, the printing layer is raised on the substrate surface in such a manner that it can be felt by touch of hand.

In other embodiment of the invention, UV spot coating registered over the printed matter is performed to provide tactile effect to the text, images or at any other desired location. The coating is UV curable, which provides protection to printed matter as well as tactile effect to the surface.

In further embodiments, inks mixed with glitter particles may be applied on desired locations by rotogravure printing machine for producing tactile and/or glitter effect. The glitter particles also provide a rough surface which gives tactile effect that can be felt by hand in addition to glitter effect in the printed matter.

The speed of the printing process is increased by using UV LEDs to cure UV curable inks in printing process of the present invention. UV LEDs emit UV radiations of specific wavelength, which is suitable for photo initiators designed to activate at that wavelength in specific inks. Therefore, the inks get cured properly in much shorter time as compared to that by UV lamps. Further, the life of UV LEDs is much higher as compared to conventional UV Lamps known in the art. The heating problem associated with UV lamps is also eliminated by use of the UV LEDs in present invention.

According to another aspect of the present invention, thick ink layers are printed using multicolour printing inks. Different colour tones can be produced in a single printing process with the printing machine of the present invention. Relatively larger volumes of ink can be transferred to the substrate for thick layer deposition of the ink with printing cylinder engraved with cell depth of about 20 microns or above up to 300 microns. The ink layer thereby produced on the printed substrate can be easily felt by touch. So by using the printing machines according to the present invention, not only the visual colour appearance, but also the tactile characteristics of a printed matter on the substrate can be specially reached.

According to further aspect of the invention, rotogravure printing cylinders with specially designed and engraved cells are described. The printing cylinders with engraving in accordance with the present invention are able to transfer larger volume of ink mixed with or without glitter particles, to deposit thick ink in comparison to conventional rotogravure printing cylinders known in the art.

The other objects and characteristic features of the present invention will become apparent from the description of the invention to be given in detail hereinafter with reference to the accompanying drawing.

### BRIEF DESCRIPTION OF THE DRAWINGS

FIG. 1 is a top view of a section of printed finished flexible substrate (100) produced through the defined process (300), according to an embodiment of the present invention;

FIG. 2A depicts cross section structure of a finished printed flexible substrate web having tactile and glitter effect when the substrate (200) is opaque, according to an embodiment of the present invention;

FIG. 2B depicts cross section of a finished printed flexible substrate having tactile and glitter effect when the substrate (201) is transparent, according to another embodiment of the present invention;

FIG. 3 depicts flowchart diagram explaining various steps of the printing process (300) on the printing apparatus (400) of FIG. 4, according to an embodiment of the present invention;

FIG. 4 is a representational view of a typical printing apparatus (400) which incorporates a plurality of printing stations, a coating station, and a plurality of curing units, according to an embodiment of the present invention.

FIG. 5 depicts a section of typical engraved rotogravure printing cylinder cells, according to an embodiment of the present invention;

### DETAILED DESCRIPTION OF THE PREFERRED EMBODIMENTS

For a thorough understanding of the present disclosure, reference is to be made to the following detailed description in connection with the above-mentioned drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the present disclosure. Further, it will nevertheless be understood that no limitation in the scope of the disclosure is thereby intended, such alterations and further modifications in the figures and such further applications of the principles of the disclosure as illustrated therein being contemplated as would normally occur to one skilled in the art to which the disclosure relates. Also, it is to be understood that the phraseology and terminology used herein is for the purpose of description and should not be regarded as limiting. Further, reference herein to “one embodiment” or “an embodiment” means that a particular feature, characteristic, or function described in connection with the embodiment is included in at least one embodiment of the disclosure. Furthermore, the appearances of such phrase at various places herein are not necessarily all referring to the same embodiment. The terms “a” and “an” herein do not denote a limitation of quantity, but rather denote the presence of at least one of the referenced item.

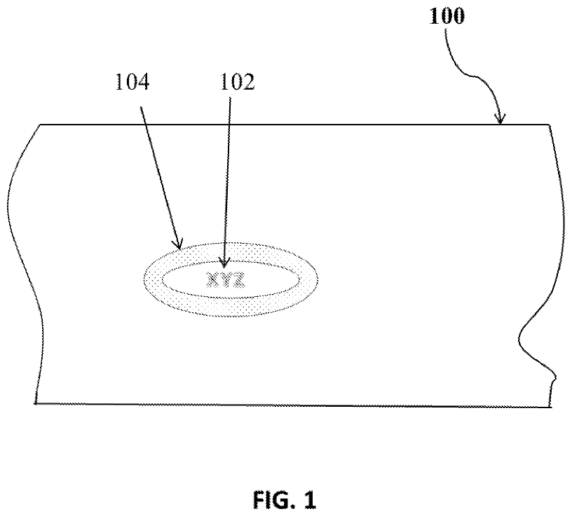

Referring to FIG. 1, top view of a printed substrate (100) showing printed information or design such as a logo (104) and a text (102) matter with tactile and glitter effect. The tactile effect herein refers to raised printed surface that can be felt by touch and the glitter effect refers to sparkling of the printed design in mono-color or combination of colors for building eye appeal. The substrate web (100) may either be a single layer film or multi-layer films of a polymer or a laminate thereof. The substrate includes, but not limited to, various kind of films, laminate structures, single layer substrate, multi-layer paper—polymer laminate, paper—Aluminum laminate, polymeric laminate, single or multilayer polymeric films, fibrous substrate, woven polymeric fabric and its laminates, metal foils, etc.

Examples of fibrous substrate may include a natural fibre substrate like paper (coated or uncoated), paperboard, non-woven, woven substrate of synthetic fibres and polymeric tapes.

Further, examples of single or multilayer polymeric films may include one of or combination of Polyethylene (PE), Biaxially-Oriented Polypropylene (BOPP) film, Polyvinyl Chloride (PVC) film, Poly Carbonate (PC), Cast Polyproylene (CPP) film, Polytetrafluoroethylene, Biaxially-Oriented Polyethylene Terephthalate (BoPET), Polyamide (PA), Acrylic (Polymethyl methacrylate) (PMMA)), Acrylonitrile Butadiene Styrene (ABS) and Ethylene Vinyl Acetate (EVA) or any other polymer.

The substrate web (100, 200, 201, 400A) of the present invention may be opaque or transparent having a top surface (200A, 201A) and a bottom surface (200B, 201B). In one embodiment of the present invention, the top surface (200A) of the substrate web (200) is printed with information or design (202, and 204) especially if the substrate is opaque. The tactile and glitter effect may be built in the printed information or the design (202, 203 and 204) by printing with radiation curable inks mixed with or without compatible glitters or any other effect pigment. However without departing from the scope of the present invention, the tactile effect may also be built by applying clear coat (206, 208, and 210) of radiation curable coating. In various embodiments, the curable coating may be applied at desirable location registered over ink printed area (206 and 208) and/or on all over the surface of the substrate web. Such curable coating also provides high gloss to the printed surface besides protection from scratch and avoids glitter shedding.

Glitter particle refer to an assortment of small, colourful, reflective particles. Glitter particles available as effect pigments that reflect light at different angles, causing the surface to sparkle or shimmer. Such pigments can also provide effects like metallic, pearl, silky or mat. Another form of glitter particles include flakes of synthetically produced polymeric substrate which has a different inherent interference colour. The flake-form substrates described above can be produced by the process described in EP 763 573 A2 and U.S. Pat. No. 9,605,155. It is apparent to a person skilled in the art that other compatible glitter or special effect particles may also be used without deviating from the scope of the present invention.

Optionally, bottom surface (200B) of the substrate (200) may be metallized and/or laminated with layers of other substrate, metal foil etc. suitable for product to be packaged, to enhance barrier properties of the packaging substrate and prevent decontamination of the product.

In case the substrate web (201) is transparent, the bottom surface (201B) of the substrate web (201) may be reverse printed with the desired information or design which can be seen through the material from top surface, followed by radiation curable coating at desired locations on the top surface of the substrate (201), registered with the matter printed on the bottom side. On the top surface (201A), a radiation curable coating composition mixed with or without glitter particles may be applied to provide tactile effect with gloss. Both spot and/or overall coating may be applied as per requirement. Optionally, bottom surface (201B) of the substrate (201) may be metallized and/or laminated with other substrate or metal foil, suitable for product to be packed, to enhance barrier properties of the packaging substrate and prevent decontamination of the product.

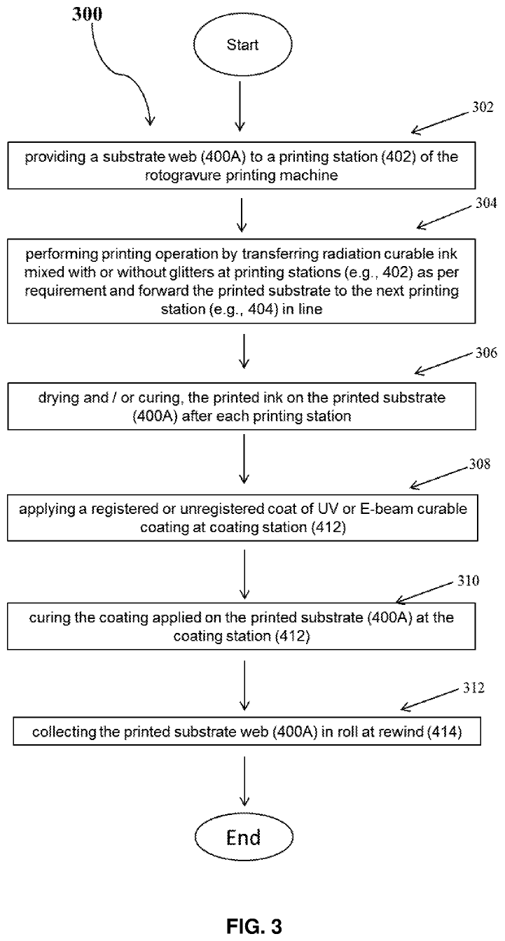

The ink composition and/or the coating composition used in the present invention are curable with various technologies such as Ultraviolet light and Electron Beam however Ultraviolet light produced using UV LED is preferred mode of curing in the present invention to enable fast curing. The ink composition, coating composition, and glitter particles are described in later part of this disclosure in conjunction with FIGS. 3,4 & 5.

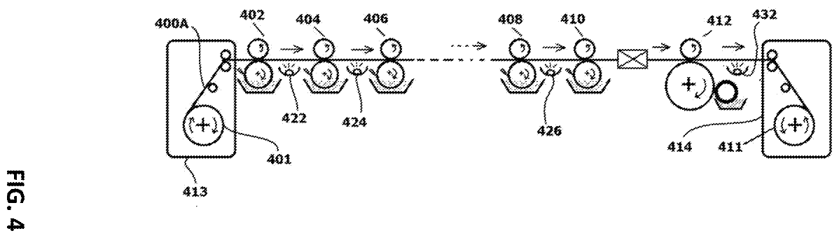

In other embodiments, the tactile effect is built by transferring and depositing large volume of radiation curable printing ink or the ink mixed with compatible glitters particles or any other effect pigment on the substrate web. It is apparent to a person skilled in the field of industrial printing and flexible packaging that rotogravure printing machine is suitable printing machine for transferring printing inks among various type of printing machines. The structure and functioning of the rotogravure printing machine for performing the purpose of this invention is described in later part of this disclosure in conjunction with FIGS. 4 & 5.

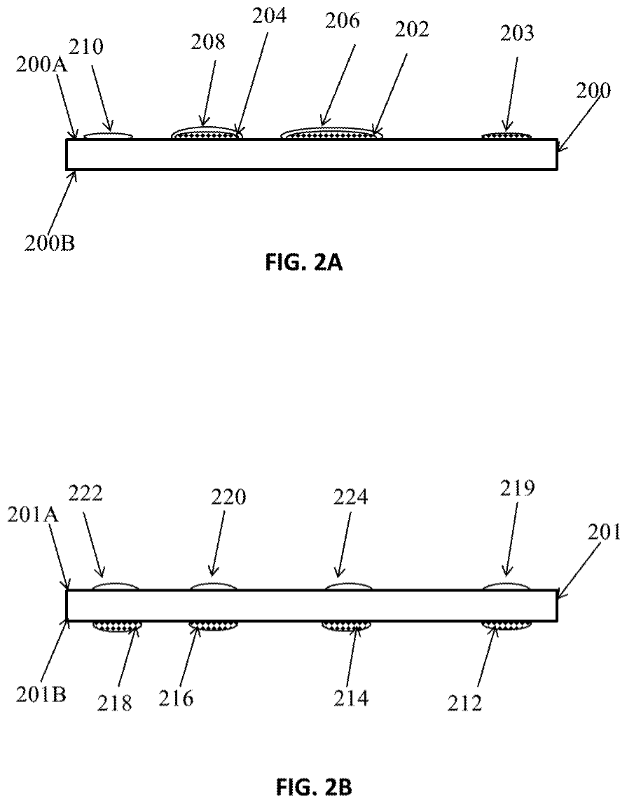

FIGS. 2A and 2B show a printed and coated substrate according to an embodiment of the present invention. The substrate includes various printed areas, with tactile effect, spot coated areas with tactile effect and areas printed with glitter mixed inks, which also provide rough/raised surface, which can be felt by touch. As illustrated in FIG. 2A in cross section, the deposited design materials on substrate (200) include not only thick ink deposits, they may also include deposit of ink mixed with or without compatible glitters or any other effect pigment and/or a layer of coating material mixed with or without glitters deposited over the printed text or design (after the inks are suitably subjected to a curing step).

In case of opaque substrate, the top surface (200A) of the polymeric substrate (200) includes at least one print information (202, 203 and 204). The print information may be a text or design added by depositing thick ink and/or ink mixed with glitters or any other effect pigment. The printing of various texts or design of the print information may be unregistered or registered with some reference mark. The addition of glitter provides tactile and/or glitter effect to the printed substrate. A spot coating (206 and 208) of radiation curable coating material mixed with or without glitters may be applied over the print information as per the requirement. As shown in FIG. 2A, a rough tactile coating (210) may be applied either directly to a substrate (200), or may be applied over the printed ink (203, 204) to provide a tactile feel to the image or printing created by the printed ink.

Further as illustrated in FIG. 2B in cross section, in case of transparent substrate, the bottom surface (201B) of the polymeric substrate layer includes at least one print information (212, 214, 216 and 218). The print information may be a text or design added by depositing curable ink mixed with or without glitter or any other effect pigment. The printing of various texts or design may be unregistered or registered with some reference mark. The addition of glitter provides glitter effect to the printed substrate. A spot coating (219, 220, 222 and 224) of curable coating material mixed with or without glitter may be applied on the top surface (201A) of the printed substrate as per the requirement.

Spot coating, as the name suggests, a radiation curable coating or “varnish” is applied to chosen spots (areas), of a printed area. This has the effect of highlighting and drawing attention to that part of the design, but it also provides the additional visual stimulus of having varied textures on a single printed surface, besides providing surface protection and gloss.

In accordance with the invention, tactile refers to generally raised thick structures printed or coated onto a substrate in a predetermined pattern using a radiation curable coating composition. The radiation-curable coating composition can be UV-LED curable or EB curable. An EB curable coating may comprise an acrylate oligomer; an acrylate monomer; optionally at least one additive such as a wetting agent, de-foamer, slip agent, stabilizer, dispersant, optical brightener, pigment dispersion, and/or dye; and optionally one or more non-radiation cross-linkable inert resins dissolvable in the acrylate monomer and/or oligomer. A UV-LED curable binder may comprise an acrylate oligomer; an acrylate monomer; a photo-initiator; a cure accelerator; optionally at least one additive such as a wetting agent, defoamer, slip agent, stabilizer, dispersant, optical brightener, pigment dispersion, and/or dye; and optionally one or more non-radiation cross linkable inert resins dissolvable in the acrylate monomer and/or oligomer. The present invention is applicable over a wide range of formulations as known by those skilled in the art of formulating radiation curable binders to target viscosity and desired cured surface properties.

The radiation curable composition can be applied through a flexographic (flexo) process or a gravure process. The radiation curable coating compositions are capable of being applied at normal production speeds of the above mentioned processes.

FIG. 3 depicts flowchart diagram explaining various steps (302, 304, 306, 308, 310 and 312) of the printing operation on the rotogravure printing machine (400), according to an embodiment of the present invention. As shown in FIG. 3, the process of printing operation includes the step (302) of providing the flexible substrate web (400A) from a roll (401) on the unwind (413) to the printing station (402) of the rotogravure printing machine (400). The process (300) further includes the step (304) of performing printing operation by transferring curable ink mixed with or without glitter at printing stations (e.g. 402) as per requirement and forward the printed substrate to the next printing station (e.g., 404) in line. At least one of the printing stations (402, 404, 406, 408 and 410) may be equipped to print by transferring radiation curable ink mixed with glitter or other effect pigments. The printing by different printing stations may be registered with a reference mark or already printed text or images.

The process (300) further includes the step (306) of drying and/or curing, the printed ink of the printed substrate (400A) between each two printing operations. The drying is required to remove the solvent present in the ink printed on the substrate; the drying operation may be carried out by hot air blower (not shown in FIGS.) through which the printed substrate pass before moving to the next printing station. The curing may be performed by using curing units (422, 424 and 426) which may be Electron Beam (E-Beam) or UV radiations based on the inks used in printing process; however UV LED is preferred mode of curing. Drying by hot air blower or curing by UV or E Beam is apparent to a person skilled in the art of rotogravure printing of flexible packaging substrate including paper and board.

The number of printing stations may vary according to requirement and number of colors to be printed. The process further includes the step (308) of applying a coat of curable coating mixed with or without compatible glitters or any other effect pigment. The coating station (412) receives the printed substrate, after it passes through all the printing stations (402, 404, 406, 408 and 410). The coating station (412) applies the clear coat of radiation curable coating mixed with or without glitter or any other effect pigment. Such coating provides abrasion protection and gloss to the printed text of images. It may be appreciated that in case of transparent substrate (201) the printing may be done in reverse on the bottom surface (201B) of the substrate (201) and coating may be applied on the top surface (201A) of the substrate, registered or unregistered with the already printed text or images, as shown in FIG. 2B. To perform printing and/or coating on both surfaces of the substrate inline a web turner (shown as cross ‘X’ sign) or similar arrangement is employed to reverse the web surface on the printing machine. Alternatively the printing and coating operations are performed in two passes i.e. reverse printing on one surface of the substrate in first pass and tactile printing and coating on the other surface in the second pass. The process (300) further includes the step (310) of curing the coating applied on the printed substrate (400A) by the coating station (412). The process (300) further includes the step (312) of collecting the printed substrate web (400A) at rewind (414).

FIG. 4 is a view of a rotogravure printing machine (400) which incorporates an unwind (413), a plurality of printing stations (402, 404, 406, 408, 410), a coating station (412), a plurality of curing units (422, 424, 426, 432), and a rewind (414), according to an embodiment of the present invention. Flexible substrate web (400A) is introduced to the process as a supply roll (401) for continuous feed to the process. The unwind (413) holds the roll (401) of the substrate (400A) to be printed and provides the substrate web (400A) to the printing station (402) in line. It is appreciated that the unwind, the rewind and other various rollers or printing cylinders are controlled by a controlling unit such as programmed computer, PLC or similar devices with suitable sensors to work in tandem and registration control. The various rotating elements are driven by suitable motors such as servo motors or stepper motors.

The substrate (400A) web onto which the designs and/or texts to be printed is passed through various printing stations (402, 404, 406, 408, 410) in a sequential process. It is to be appreciated that, although the number of such stations corresponds generally to the number of color variations, other complexities and finishing layers, the number of such stations may be increased or decreased as required. The dotted lines in FIG. 4 represent the flexibility to addition or removal of printing stations as per requirement. For example if more than five colours are used in printing process as shown in the FIG. 4, then more stations can be added to the printing apparatus. In case less than five colours then stations can be removed as per requirement.

The cross shown in a typical location depicts inline web turner or similar arrangement employed to reverse the transparent substrate web after printing on a surface through desired number of printing stations.

The printing station (402) receives the substrate web (400A) and performs printing in particular color on the substrate and the printed substrate moves to the next printing station (404) in line. Each printing stations (402, 404, 406, 408 and 410) typically comprises a printing cylinder, an impression roller, a doctor blade and an ink tray (415). Since the printing cylinder, the impression roller, the doctor blade, and the ink tray (415) are apparent to a person skilled in the art, so details of these are skipped for brevity. The controlled application of the ink mixed with or without glitters or any other effect pigment from the ink tray (415) to the printing cylinder is then transferred to the continuously moving substrate web with the pressure of impression roller. It is to be appreciated that the thickness of transferred ink is proportional to the engraving on the printing cylinder i.e. at the portion where engraved cell is deeper, larger amount of ink is transferred over substrate thereby resulting in raised thicker layer providing tactile effect.

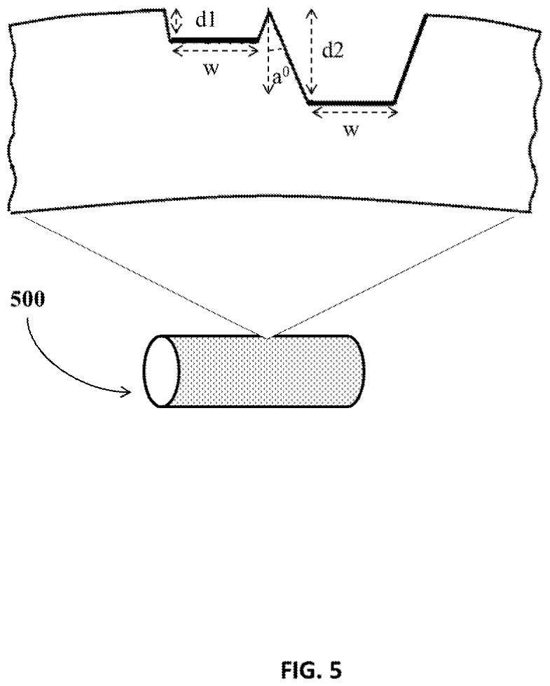

The printing cylinder (500 as shown in FIG. 5) of at least one printing stations may be engraved with a depth (d1, d2), angle (a), and width (w) to enable the cylinder to transfer and deposit a large volume of printing radiation curable ink mixed with glitter or other effect pigments on the substrate for building tactile and/or glitter effect or other effects due to effect pigments as discussed earlier. The printing cylinder (500) is described in detail later in conjunction with FIG. 5.

It should be appreciated that after printing by printing station, the printed surface will typically require drying and/or curing for stability and permanence. Accordingly, a hot air blower (not shown) and/or a radiation curing unit is placed between two consecutive printing stations through which the printed surface of the moving substrate is passed. At least one of the printing stations (402, 404, 406, 408 and 410) includes a curing unit installed on it for curing of the ink and enhancing the quality of the print up to the desired level. In addition to these curing units, the printing stations may also include hot air blower for drying the ink and enhancing the quality of print. The curing unit is a UV LED light source or E-Beam source where the ink mixed with or without glitter and/or other effect pigments, is radiation curable. Reference to “curing unit” in this disclosure contemplates selection and employment of any of these alternatives such as but not limited to such as E Beam source, UV LED source, for curing the printed materials. While further control of the process speed may be required at the curing stations depending on time requirements for the curing of the materials, these variations can easily be accomplished efficiently by computer-controlled process elements well known in production industries and which are contemplated to be usefully employed in the present invention.

After the first printing/drying/curing at the print station (402), the process may be repeated numerous times at subsequent print stations (404, 406, 408, 410) and curing units (422, 424, 426) in line, the additional print of text or designs or patterns being applied in a closely controlled registration with the previously printed text, images or mark. At final station i.e. coating station (412), where a final protective clear radiation curable coating is applied after all the separate printed elements are accomplished in line. It may be appreciated that the coating is a radiation curable clear coating. The radiation curable coating may also be mixed with glitter and/or other effect pigments to produce the desired effect and gloss with protection of printed matter on the packaging substrate. The coating may be spot coating registered with reference mark or text or image printed on the substrate. In various embodiments of the present invention, the coating station (412) may be based on a flexography or a rotogravure process. A curing unit (432) is placed after the coating station (412) for curing the coating applied on the substrate (400A). The entire inline printed substrate web then taken in roll (411) by the rewind (414) and used for further processing of the printed materials such as slitting, pouching and shaping as per the finished packaging requirements.

FIG. 5 shows a cross section of the printing cylinder (500), according to an embodiment of the present invention. The printing cylinder (500) is configured for transferring desired quantity of inks with respect to the design or text to be printed on the substrate. The design or texts to be printed are etched or engraved on the surface of the printing cylinder (500) known as cells or wells. The depth (d1 and d2), angle (a), and width (w) of the cells may vary as per the requirement and specification of desired thickness of the printed object on the substrate. In a preferred embodiment, the engraving depth (d1 and d2) is between 20 microns to 300 microns preferably 50-150 microns, the engraving angle (a) is between 15 to 70 degrees to provide print with tactile effect with or without glitter or other effect pigment(s). It should be appreciated that the printing cylinder may be engraved using various engraving technology including but not limited to, mechanical, chemical etching, laser.

According to an embodiment, the printing cylinder utilizes an ink tank containing ink of suitably maintained viscosity of desired color mixed with or without compatible glitter particles or any other effect pigment. In an alternate embodiment, the printing cylinder utilises a fountain roller, a cloth-covered roller that is partially submerged in the ink fountain and which contacts the surface of the gravure cylinder. In further embodiments, the ink may be directly sprayed onto the surface of the printing cylinder by a nozzle.

As discussed earlier above, at least one of the printing stations (402, 404, 408) includes an Ultra-Violet Light Emitting Diode (UV-LED) curing units installed on it for curing of the ink and enhancing the quality of the print by drying the ink up to the desired level. In addition to these UV-LED curing systems, the printing stations may also include hot air blower for drying the ink and enhancing the quality of print.

With the help of printing machine of present invention, high speed multicolour raised printing is achieved. Further, one can feel by touch the printed content on the substrate due to thickness of the transferred ink which is in the range of 50 microns to 300 microns as per the requirement. The speed of the printing is as high as 400 m/min. is possible due to faster UV LED curing of the compatible radiation curable printing inks.

The multicolour rotogravure machine, of the present invention, for printing on flexible web substrate uses the UV LEDs, instead of the UV lamp's UV to cure the solvent based inks, for high speed printing process. The UV LEDs used for high speed curing emit a light of specific wavelength, which is suitable to crosslink and cure the ink by activating photo initiators designed for that specific wavelength in the compatible inks. Therefore, the inks get cured properly in much shorter time as compared to that by UV lamps. Further, the life of UV LEDs is much higher and de rate least as compared to that of the UV Lamps known in the art.

Other special effect such as glittering of the printing may also be added by mixing suitable glitters or any effect pigment(s) with the inks with faster curing/drying mechanism of the present invention.

Although, the invention has been described with specific reference to the UV LED curing light, it may be contemplated that E-beam curing system with compatible inks and suitable modification may be used to carry out the process and use of UV LED in no way restrict the apparatus or process as described above.

The foregoing descriptions of specific embodiments of the present disclosure have been presented for purposes of illustration and description. They are not intended to be exhaustive or to limit the present disclosure to the precise forms disclosed and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the present disclosure.

1-22. (canceled)

23. A process of printing with tactile effect on flexible substrate by rotogravure printing machine, the process comprising:
providing a substrate web in roll from an unwind to a first printing station of the rotogravure printing machine;
printing by transferring radiation curable ink from a printing cylinder to the substrate at the printing station;
drying and/or curing, the printed ink on the printed substrate after printing and forward the printed substrate to the next printing station in line;
applying a registered or unregistered coat of radiation curable coating at a coating station;
curing the coating applied on the printed substrate by a radiation source; and
collecting the printed substrate web in roll at rewind,
wherein a layer of 20 to 300 microns thick ink is deposited at predetermined locations on the substrate to provide tactile effect.

24. The process according to claim 23, wherein the substrate web is opaque or transparent or translucent.

25. The process according to claim 23, wherein the substrate is reverse printed on bottom surface and the coating is applied on top surface.

26. The process according to claim 23, wherein the substrate is printed on top surface and coating is applied on same surface.

27. The process according to claim 23, wherein the ink is mixed with glitter or other effect pigments.

28. The process according to claim 23, wherein the coating is applied in registration over printed matter of the substrate web.

29. The process according to claim 23, wherein the coating is applied all over the substrate web.

30. The process according to claim 23, wherein the coating layer of 20 to 300 microns is applied to provide tactile effect.

31. The process according to claim 23, wherein the coating is mixed with glitter.

32. The process according to claim 23, the radiation to cure the print is UV or E-beam.

33. A printing apparatus comprising:
an unwind for providing a substrate web from roll;
a plurality of rotogravure printing stations for printing on the substrate web, each of the printing stations having an engraved printing cylinder and an impression roller;
an in-line coating station for applying layer of curable coating composition on the substrate web; and
a rewind for collection of the printed substrate in roll;
wherein a printing cylinder at least one of the printing stations being engraved with cells or wells having a depth of 20 to 300 microns, an angle (a) of 15 to 70 degree corresponding to a width suitable to effectively allow transfer of thick curable ink to provide tactile effect on the substrate web, and
at least one printing station and the coating station is provided with a radiation curing unit for curing the ink and coating, inline, respectively.

34. The apparatus according to claim 33, wherein the engraved depth on printing cylinder is 50 to 100 microns.

35. The apparatus according to claim 33, wherein the curing unit is an array of UV LEDs.

36. The apparatus according to claim 33, wherein the curing unit is an E-Beam radiation source.

37. The apparatus according to claim 33, wherein the coating station is based on flexography or rotogravure process.

38. The apparatus according to claim 33, wherein at least one printing station comprises hot air blower for drying the transferred ink on the printed substrate.

39. A printed substrate prepared by the process of claim 33, the substrate comprising:
a top surface; and
a bottom surface,
wherein a layer of 20 to 300 microns thick ink is deposited at predetermined locations on the substrate to provide tactile effect on at least one of its surfaces.

40. The printed substrate of claim 39, wherein ink is mixed with glitter or effect pigment.

41. The printed substrate of claim 39, wherein the substrate is single layer or multi-layer.

42. The printed substrate of claim 39, wherein the substrate web is opaque or transparent.

43. The process of claim 39, wherein the substrate is reverse printed on bottom surface and a coating is applied on top surface.

44. The process of claim 39, wherein the substrate is printed on top surface and a coating is applied on the same surface.
